(19) United States
(12) Patent Application Publication
(10) Pub. No.: US 2009/0292690 A1
(43) Pub. Date: Nov. 26, 2009

(54) Method and System for Automatic Event Administration and Viewing

(75) Inventor: Daniel Culbert, Los Gatos, CA (US)

Correspondence Address: Daniel Culbert, 16170 Jasmine Way, Los Gatos, CA, 95032, US

(73) Assignee: Daniel Jason Culbert, Los Gatos, CA (US)

(21) Appl. No.: 12/250,773

(22) Filed: Oct. 14, 2008

Related U.S. Application Data
(60) Provisional application No. 61/128,579, filed on May 23, 2008.

(51) Int. Cl. G06F 17/30; G06F 15/16; G06F 3/048

(52) U.S. Cl. 707/5; 707/104.1; 709/206; 715/821; 707/E17.009; 707/E17.069

(57) ABSTRACT

This is a method and system for automated calendar event creation from unstructured text, with assisted administration and viewing.

### CROSS REFERENCE TO RELATED APPLICATIONS

This application claims the benefit of provisional patent application Ser. No. 61/128,579, filed 2008 May 23.

### TECHNICAL FIELD

This invention relates to electronic mail systems, computer based calendar systems, and the Internet.

### BACKGROUND ART

Two of the major productivity tools available today on computer systems are electronic mail (email) and calendar applications. Email originated as a pure electronic version of a mail/message delivery system. Calendar applications began as a straight translation of a pen and paper based personal organizer calendar implemented on a computer. Since then, many features have been added onto both applications. A few examples include IMAP4 and improved user-client front ends for email and, for calendars, meeting invites, subscribing to published calendars, and scheduling assistance. With the fast growth of the web, email use has exploded in size and volume—so much so that email systems frequently have trouble organizing and protecting the user from unwanted email messages (spam), and even the sheer volume of valid emails.

Calendar systems in comparison have remained more closed and proprietary, and while large progress has been made in supplying users of any given calendar sources from which they can subscribe/insert events into their calendar, the management systems of these calendar tools are frequently incompatible (as opposed to universal use of email protocols such as IMAP and POP), and have not kept up with the increase in electronic communication and styles. The majority of modern calendar applications, at their core, are still representations of the basic pen and paper datebook calendar—they have a day view, a week view, a month view, and occasionally a year view, with the ability to have multiple calendar channels overlaid on the same display page. These channels are separate groups of events, which the user can create, find (on the web), and individually enable/disable in their view. Typically, these groups share a specific category (e.g. DVD release dates, or Work vs. Home events), and are rendered in the same color or identifying mark. In U.S. Pat. No. 7,039,598 to Lu (2006), these channels may be entirely separate calendars. Scheduling is the area with the most progress and inventions, examples include U.S. Pat. No. 7,318,040 to Doss et al. (2008), which describes predicting and adjusting future working hours and calendar events for users of electronic calendars, and U.S. Pat. No. 7,411,942 to Croak et al. (2008), which describes a method of reserving appointments over a network. Basic calendar management is the next major area of progress, with examples such as Pat. No. 7,149,810 to Miller et al. (2006), which expand upon management features protecting past events, and recurring events. U.S. Pat. No. 7,325,198 to Adcock et al. (2008) capitalizes on a calendar management interface, and uses a calendar construct and graphical user interface to organize photos—here the utility is about helping view photos taken, as opposed to using images to help base calendar management.

Although these tools increase user productivity over the absence of any such tool, their usage doesn't scale well. Faced with large volumes of outside (unstructured) event information through mediums such as email, and even large volumes of internal separate calendar channels or events from which to subscribe, the user must still manually manage a large percentage of their calendar, and, more importantly—the calendar events for the user, in their entirety, more often than not do not represent the user's true schedule, significantly hindering tools like automatic scheduling that expect the calendar to be precise or exact. Commonly, those entries that are personal in nature (i.e. not pre-published in a ready-made calendar channel, or where the introduction/interest in an event is a personal preference) require the most manual effort. There are a few existing email/calendar systems that auto-fill and assist the user in creating calendar events from unstructured data such as Google Gmail/Calendar or Apple Mail, but none of them take the final step of auto-creating or updating events from information outside the calendar system without any user intervention, and, in all of them, the user is forced to remember to edit/modify that event as new information arrives (e.g. via email). What is lacking is a fully automatic calendar event creation mechanism with provisions in place to dynamically and quickly adjust these events, or how they are viewed, when necessary.

### SUMMARY OF THE INVENTION

This is a method for automatic calendar event administration and viewing. In addition to traditional calendar administration techniques, this system includes the ability to automatically add calendar entries directly based on parsing incoming email, and alternate sources (e.g. the Web). Entries are overlaid, positioned, and colored according to their priority (not category), which is both a measure of the importance of this event to the user, as well as a measure of an estimate of the accuracy that the entry is valid (not in error). One email or alternate data source may create multiple calendar entries. Entries are also automatically removed or moved according to new email or new data from alternate sources that pertain to the event created. The user can quickly visually remove unwanted entries by simply moving a slider or single control that sets a filter threshold for events shown based on their priority/validity. Automatic event creation scales easily with large increases in email or alternate source activity and keeps the calendar up to date and full. Global controls such a single slider and values such as an event score allows the user to quickly discard, highlight, or otherwise adjust these events, and assists this automatic system in keeping the user's calendar relevant.

In an integrated system, there is no separate calendar event storage—email and calendar are one and the same tools, with each just being a different view of the same data or integrated data.

### BRIEF DESCRIPTION OF THE DRAWINGS

FIG. 1 is a diagram of the process by which a calendar entries are automatically added or marked and deleted.

FIG. 2 is a diagram of how calendar entries are dynamically selected for viewing.

FIG. 3 is a diagram of a process by which calendar entries can be adjusted by the user.

FIG. 4 is a snapshot of a calendar view with a score slider controlling which events are visible on the calendar.

### DETAILED DESCRIPTION

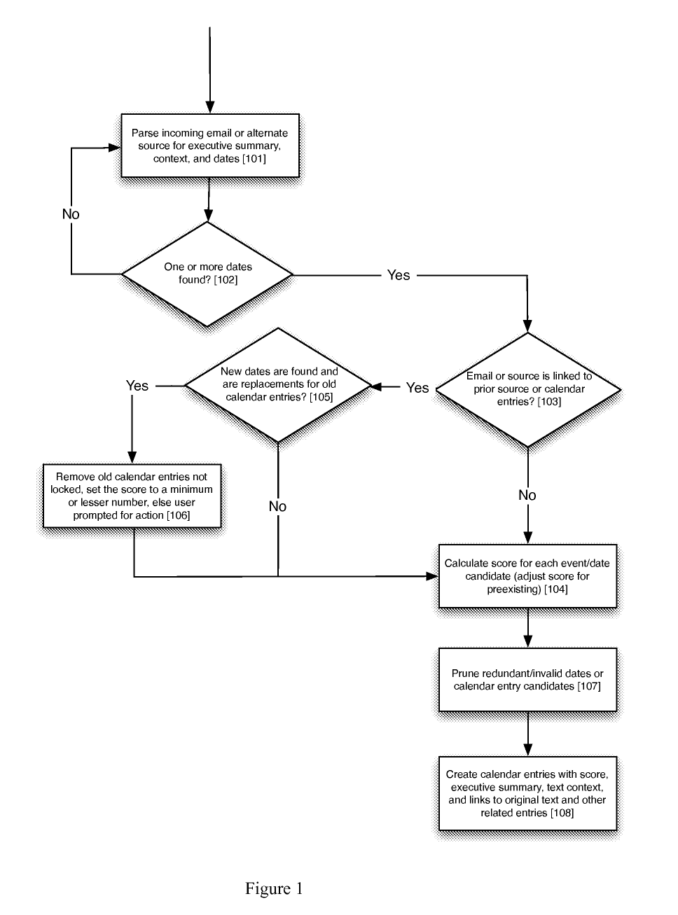

The preferred embodiment of the process by which calendar entries are automatically created or detected is shown in FIG. 1. Preferably incoming email, or any other alternate unstructured text (including the web/HTML), is first parsed for any dates, an executive summary, and any relevant text near each date [101]. Unstructured text is assumed to be any form of text that is not already formatted in a documented calendar format (e.g. vcal) that would make calendar event creation trivial, but it can also be the latter. If no dates or possible dates are found, no calendar event or additional data is created. In the preferred embodiment, partial dates are allowed, with full dates inferred using heuristics. Examples include, but are not limited to: if a day is stated (e.g. Wednesday), the closest upcoming Wednesday's date is used (no time). If a month day is detected (e.g. the 26^{th}) but not the month or year, the current month and year is assumed. In both these examples, additional context also helps set the baseline from which to extrapolate the complete date. One example is the receipt date of the source (e.g. email message) itself. The executive summary can also be created using heuristics—e.g. the subject of the email, or the Title element of a HTML page, or the text near the date if all obvious summary elements are missing, etc.

If one or more dates are found [102], a scan is then done to see if this email or source, or the calendar event candidates, are linked to prior sources or calendar entries [103]. Here, the definition of linked is a statistical measure of correlation or relation to prior sources or entries, but also includes direct links (e.g. the relation is stored directly in a database). Examples of links include, but are not limited to: the source was a reply to an earlier email that contained its own dates/calendar entry candidates, the calendar event candidate is an exact or near duplicate of a currently existing candidate, the source itself appears to be an exact or near duplicate of a prior one, or the calendar event candidate appears to be an exact or near duplicate of popular, frequently discovered entries across multiple users/sources. It should be noted that in another variation of this invention, this check and subsequent actions could be done after scoring, or skipped entirely. If links are found, and new dates are found to be replacements of the old dates (e.g. the new dates have or will have high scores, and the old dates have equal or lower scores) [105], the old calendar entries are either automatically removed, or their score, if not already low, is set to the minimum. Alternatively, depending on context, the user may be prompted on what to do with the old entries [106]. If no new dates are found, or they do not appear to be valid replacements for the prior entries, no additional special action is done for this case.

For all cases, a score is then created for each event candidate based off of each date found, the original text, and any relevant context associated with the text (e.g. prior event creations or other links [103] [104]. Scores of any linked calendar entries still existing are also recalculated, if necessary. Examples of score weights include, but are not limited to: the spam level measured for an email message source (measured by any currently existing spam filter technology, including detection of bulk emailings vs. individual), an email source was a reply to a previous email and the date is in the reply vs. the date was found in text copied from the original email (i.e. the score is adjusted as a function of the chronological history and placement within the entire email thread for the date in question), the email is from someone in the user's preferred contact list, the strength of the date inference (e.g. was the date a full date in the original text in lieu of a partial), and the uniqueness of the date in general (e.g. did the unstructured text include many dates or just one), and the sent to/receive from frequency ratio for that sender in general.

After these steps, whether or not the text is found to be linked, the final list of calendar entries is pruned to remove redundant entries or entries whose score is below a bottom threshold [107]. Finally, these entries are created with their score, date, executive summary, links to the original text/email, and links to all relevant and connected calendar entries (e.g. all entries just created from this text, or linked text) [108].

In any system where events are automatically created, it is likely that the user's calendar will contain far more events than the typical calendar today. It is also possible that errant events could be created (e.g. two separate calendar entry candidates might be created from the same text: one is correct, one is incorrect). In order to retain the benefit of automatic event creation, it is critical that the user have immediate global control, including visualization, over the events on the calendar.

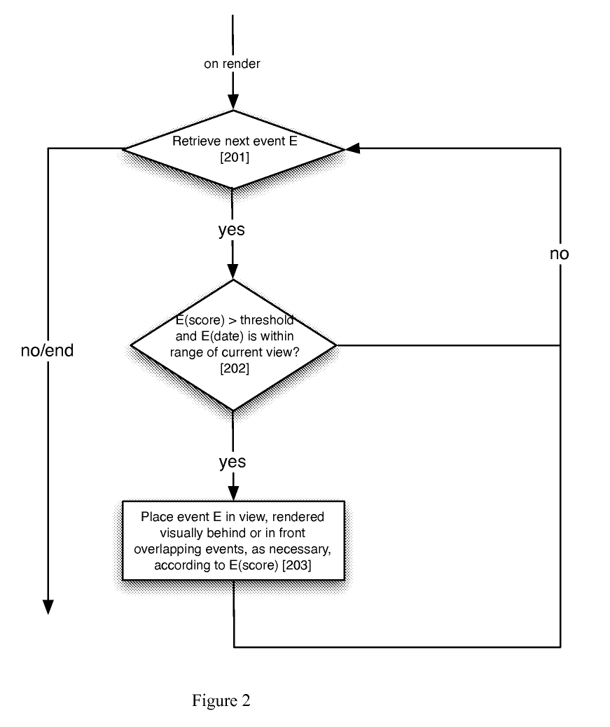

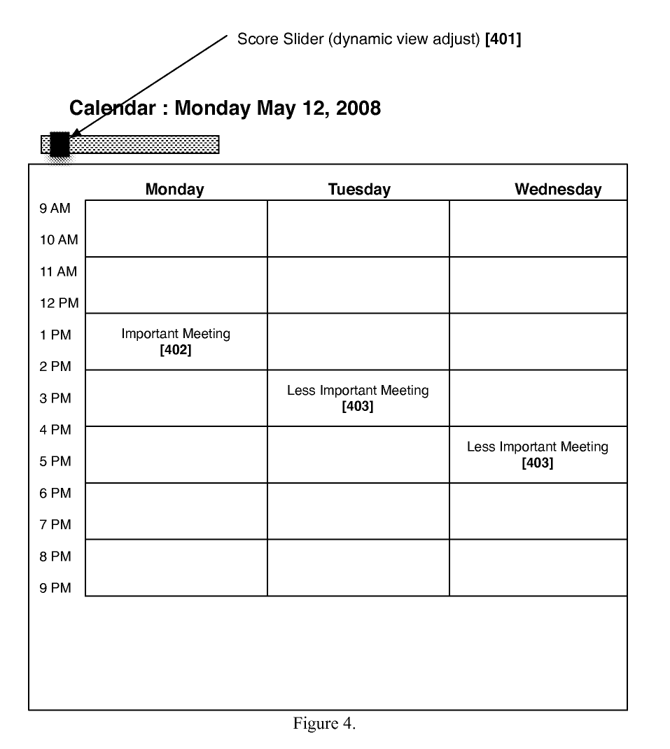

The first key control for the preferred embodiment of this invention is shown in FIG. 2 and FIG. 4. This diagram shows the event rendering process. For a day view (one day displayed), or week view (one week displayed), month view (month view displayed), or any alternate sized view in time, a dynamic filter is applied to events to be shown based solely on the score of each event and their date. First, the user adjusts a simple single slider or single input box to set a score threshold [401]. The calendar is then re-rendered, beginning with the retrieval of event candidates [201]. For each event, if the event's score (priority) is greater than the set threshold, and if the event's date is within the range of the current view selected on the calendar [202], it is rendered [203]. Otherwise it is not. If the event E is rendered, it is rendered visually behind (and slightly offset) any overlapping events with a score greater than event E's score, and visually in front of (and slightly offset) any events with a score less than E's score. If there is enough screen real estate, overlapping events can be rendered next to each other, with the position being denoted by the event outline shadow only. The rendering does not have to be completely behind or in front—visually showing prominence is all that is required. Unless overridden, each event's background color, or alternatively, the text color, is also dictated by its score. In this process, if the user sets the threshold to the max, the calendar will immediately display only the most important/relevant calendar entries. In the preferred embodiment, these entries represent entries that the user has carefully created or manually marked as important/correct. If the user sets the threshold to the minimum, all discovered entries will be shown. Thresholds set in between render a set of events in between these two. Such a system not only allows the user to quickly visualize and adjust large amounts of calendar events—it also allows them to quickly fill/see possibilities for calendar dates that do not contain important/top score events (e.g. all choice dates/time for a meeting not yet set are rendered, or all event choices for an otherwise empty evening without an important calendar event can be shown). This is in contrast with alternate calendar interfaces, where the user would have to repeatedly click multiple channels on and off to get the event mix they need, or, the events they would like to visualize are not even present since they were not automatically created.

In order to highlight any new calendar entries, the preferred embodiment of this invention also includes the ability to temporarily highlight—via a different color, border, or border animation—new automatically created entries or entry candidates independent of their score, or rather, temporary increase the score of new calendar entries. This rendering can be done in any manner, but it is preferred that it be complimentary and not mutually exclusive or conflicting in how all other calendar entries are rendered. This allows the user to quickly identify new entries, and take action on them.

A visual example of a simple calendar system with global threshold control is shown in FIG. 4. By adjusting the slider [401] to the minimum setting, only important events [402] will be rendered. By adjusting the slider to the maximum, all events will be rendered [402,403].

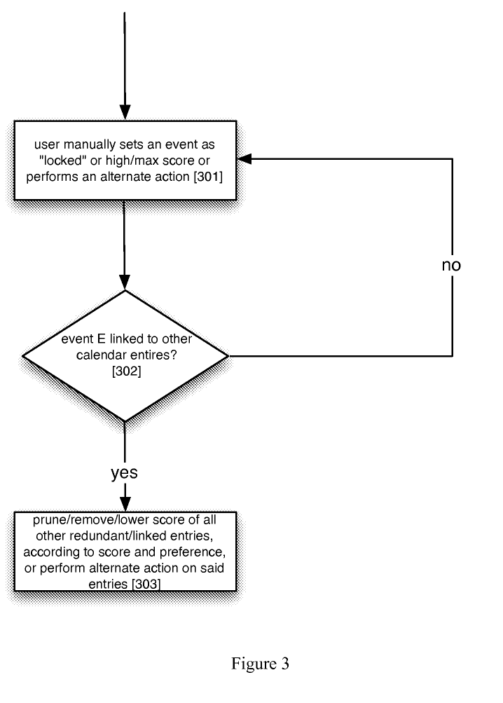

The second key user calendar control for the preferred embodiment of this invention is the ability of the user to quickly adjust or mark a particular event of a set as valid/unique, or perform an alternate action that globally modifies that event and all related events. This is shown in FIG. 3. Since it is possible for the automated system to find multiple candidate dates from a source (e.g. someone sent an email with three choices of dates, and later confirmed verbally or via email which was the right date), and not automatically detect that it should remove or adjust a particular entry instead of creating a new one, in this case, the user must adjust their calendar. For a particular group of events that originated all from the same text source, or were linked via the process in FIG. 1 to other calendar entries, by clicking on any one event (or any other alternate control that references that event) that the user knows is the right date and time of a valid event, or of interest in some other fashion [301], the user can mark this event as valid/unique, or perform an alternate action across the entire group of events. In doing so, all the other related events are immediately dropped from the calendar without further user intervention [302,303], or, alternatively, adjusted according to the user's wish (e.g. all events should be raised in priority). The net result is a single user click (on occasion), as opposed to the user repeatedly updating/changing an event with the new information.

In the preferred embodiment of this invention, the single source of unstructured text that is used as the source for calendar entries is email, as this is a primary source from which users receive calendar-worthy notes from work, friends, or favorite websites that send email updates. In an alternate variation of this invention, other sources could also be linked in and used, which include, but are not limited to: SMS, favorite websites (direct from the site, not via emails), published databases or calendars, or the entire web in general (filtered by high level preferences)

In the preferred embodiment of this invention, a calendar and email application are an integrated system—there is no separate calendar event storage, or, at a minimum, each application component has full access to the other's data. One example would be to store additional calendar event data as headers or as separate emails within a specific folder on an IMAP server. Another would be to add additional link and parsed mail information into a traditional calendar event database. This allows for streamlined performance, and a cleaner, integrated interface (e.g. “today's” unread emails that have no additional date/event information would show up as moving event items in the current day view), assisting in presenting email and calendar data as the same tools, with each just being a different view of the same data or integrated data.

In an alternate variation, this entire system can be implemented on top of any preexisting calendar system feature set or application that has an api for event manipulation. For example, a current calendar system that uses channels or category to color calendar entries, in lieu of a score, can continue to do so. The additional automatic creation and visualization would apply only to those events automatically created, which could be done per channel or category, or, globally, for example. In another variation, the primary calendar can use background images rendered behind or around the text of each calendar event as the identifying marker for the calendar entry's category, and keep color as the marker for priority or score. In another variation, the use of background images and color could be reversed. The background images need not be square or of any traditional shape. The background images can also be used simultaneously with color—in one variation, the background images can be skewed in color according to a color chosen for the event's score if background images are used for category, or for the event's category if background images are used for score.

1. A method for automatically creating a plurality of calendar entries in a calendar application, comprising:
a. providing a computer with a means to create, modify, and delete a plurality of calendar entries within a calendar database, file, or memory,
b. parsing a body of unstructured text for possible calendar entries, where said possible calendar entries are based off of each date found, said body of unstructured text, and any relevant context associated with said body of unstructured text,
c. creating a plurality of calendar entries based on said parsing,
d. scoring said calendar entries based on said body of unstructured text, said each date found, and any relevant context associated with said body of unstructured text, and
e. adding said calendar entries to said calendar database, file, or memory, with said calendar entries comprising:
1. a score from said scoring,
2. a title,
3. a link to said body of unstructured text
whereby a user of a calendar application using said calendar database, file, or memory will have immediate access to calendar events sent via alternate means such as email without the need for manual creation of said calendar entries.

2. The method of claim 1 wherein said scoring said calendar entries comprises:
a. adjusting said score according to the strength of the date inference in said body of unstructured text,
b. adjusting said score according to the uniqueness of the date in question,
c. adjusting said score based on the importance of said body of unstructured text, or the importance of the author of said body of unstructured text.

3. The method of claim 2 wherein said body of unstructured text is email, and said score is further adjusted by
a. the spam level of the email
b. the chronological history and placement within the entire email thread for the date in question,
c. the general importance of the email sender to the recipient.

4. The method of claim 3 wherein said score is further adjusted by the sent to/receive from frequency ratio of the sender of said email.

5. A method for globally modifying linked calendar entries, comprising:
a. providing a computer with a means to create, modify, delete, and visualize a plurality of calendar entries within a calendar database, file, or memory,
b. automatically selecting a plurality of calendar entries based on a single calendar entry as selected by the user, creating a selection comprising:
1. said calendar entry as selected by the user,
2. a plurality of calendar entries that are linked to said calendar entry, and,
c. adjusting the entirety of said selected calendar entries based on a user action.

6. The method of claim 5 wherein said selection comprises all calendar entries automatically generated from scanning a body of unstructured text, wherein said selection share this body of text in common as a link.

7. The method of claim 6 wherein said body of unstructured text is an email message.

8. The method of claim 6 wherein said body of unstructured text is the aggregate text of the entire email thread from which said selection is created.

9. The method of claim 5 wherein adjusting said selected calendar entries based on a user action comprises:
a. the user marking said user selected calendar entry as valid,
b. all other calendar entries in said selection are dropped from said calendar database, file, or memory.

10. A method for rendering, visualizing, and controlling calendar entries comprising:
a. providing a computer with a means to create, modify, delete, and visualize a plurality of calendar entries within a calendar database, file, or memory,
b. rendering all calendar entries that contain a score within a predetermined score range in a manner dictated by the scores in that score range.

11. The method of claim 10 wherein said rendering all calendar entries that contain a score within a predetermined score range in a manner dictated by the scores in that score range comprises:
a. a plurality of colors used for said calendar entries that contain a score,
b. using one color per each predetermined range of scores,
c. rendering the color of each calendar entry according to its score and said one color per each predetermined range of scores,
d. rendering calendar entries with lower scores visually or prominently behind calendar entries with higher scores.

12. The method of claim 10 further including rendering calendar entries that have a category, comprising:
a. using a plurality of background images,
b. rendering each calendar event text with a background image behind or around the event text, with one background image as an identifying marker per category.

13. The method of claim 10 further including rendering calendar entries that contain a score and a category, comprising:
a. using a plurality of background images, with one background image as an identifying marker per category,
b. using a plurality of colors, with one color used per predetermined score range, and
c. skewing the background image per calendar entry towards the color used per said calendar entry as dictated by the score of said calendar entry and said one color used per predetermined score range,
d. rendering each calendar event text with its background image behind or around the event text.

14. The method of claim 10 further including rendering calendar entries that contain a score and a category, comprising:
a. using a plurality of background images, with one background image per predetermined score range,
b. using a plurality of colors, with one color used as an identifying marker per category, and
c. skewing the background image per calendar entry towards the color used per said calendar entry as dictated by the category of said calendar entry,
d. rendering each calendar event text with its background image behind or around the event text.

15. The method of claim 10 further including controlling the visible set of calendar entries by using a single slider control, wherein said control sets a threshold by which any calendar entry that has a score greater than said threshold is rendered, otherwise it is not.

16. The method of claim 15 further including automatically creating a plurality of calendar entries in a calendar application, comprising:
a. providing a computer with a means to create, modify, and delete a plurality of calendar entries within a calendar database, file, or memory,
b. parsing a body of unstructured text for possible calendar entries, where said possible calendar entries are based off of each date found, said body of unstructured text, and any relevant context associated with said body of unstructured text,
c. creating a plurality of calendar entries based on said parsing,
d. scoring said calendar entries based on said body of unstructured text, said each date found, and any relevant context associated with said body of unstructured text, and
e. adding said calendar entries to said calendar database, file, or memory, with said calendar entries comprising:
1. a score from said scoring,
2. a title,
3. a link to said body of unstructured text whereby a user of a calendar application using said calendar database, file, or memory will have immediate access to calendar events sent via alternate means such as email without the need for manual creation of said calendar entries, and single and immediate control over the volume and manner in which the calendar entries are visualized.

17. The method of claim 16 further including a method for globally modifying linked calendar entries, comprising:
a. automatically selecting a plurality of calendar entries based on a single calendar entry as selected by the user, the selection comprising:
1. said calendar entry as selected by the user,
2. a plurality of calendar entries that are linked to said calendar entry, and,
b. adjusting the entirety of said selected calendar entries based on a user action
whereby a user of a calendar application using said calendar database, file, or memory will have immediate access to calendar events sent via alternate means such as email without the need for manual creation of said calendar entries, single and immediate control over the volume and manner in which the calendar entries are visualized, and global, efficient control over modifying said calendar entries in bulk.

18. The method of claim 17 wherein said body of unstructured text is email.

19. The method of claim 18 further including temporarily highlighting new calendar entries automatically created.

20. The method of claim 19 further including rendering any unread email that does not produce any additional calendar events as moving event items in the current day view.
